(19) United States
(12) Patent Application Publication
(10) Pub. No.: US 2026/0296371 A1
(43) Pub. Date: Oct. 1, 2026

(54) ENTRY SYSTEM AND DOOR CONTROL METHOD

(71) Applicant: HONDA MOTOR CO., LTD., Tokyo (JP)

(72) Inventors: Seonghun Lee, Tokyo (JP); Mitsunori Nishino, Tokyo (JP); Genki Inohana, Tokyo (JP); Satoshi Kotoura, Tokyo (JP)

(21) Appl. No.: 19/576,414

(22) Filed: Mar. 24, 2026

(30) Foreign Application Priority Data
Mar. 28, 2025 (JP) 2025-056821

(51) Int. Cl. B60R 25/30; B60R 25/31; B60R 25/32; G07C 9/10; G07C 9/29; G07C 9/32

(52) U.S. Cl. CPC B60R 25/305; B60R 25/31; B60R 25/32; G07C 9/10; G07C 9/29; G07C 9/32

(57) ABSTRACT

An entry system includes: an acquisition section that acquires a target person image in a surrounding of a vehicle; an authentication section that performs authentication of the target person as a registered user having a usage right of the vehicle, based on the target person image; and a door control section that causes a door control device to execute automatic door unlocking and automatic door opening operation of a vehicle door under a condition in which the authentication succeeds, the door control device being configured to control locking/unlocking and opening/closing operation of the vehicle door of the vehicle. When a predetermined transitioning condition is satisfied, the door control section prohibits predetermined operation related to the automatic door opening operation during a temporary suspension period until a predetermined cancelling condition is satisfied, regardless of a result of the authentication.

### INCORPORATION BY REFERENCE

The present application claims priority under 35 U.S.C. § 119 to Japanese Patent Application No. 2025-056821 filed on Mar. 28, 2025. The content of the application is incorporated herein by reference in its entirety.

### BACKGROUND OF THE INVENTION

### Field of the Invention

The present invention relates to an entry system and a door control method.

### Description of the Related Art

In recent years, approaches are becoming active which provide access to a sustainable transportation system also considering vulnerable people such as aged people, people with disabilities, and children among traffic participants. To achieve such approaches, the focus has been placed on research and development for further improving traffic safety and convenience through development on vehicle accessibility.

International Publication No. WO 2019/003826 states that using an on-board imaging apparatus that operates in a low-resolution mode and a high-resolution mode, when a moving object in the surrounding of a vehicle is detected in an image in the low-resolution mode, a facial image of the moving object in the high-resolution mode is acquired and authentication processing of the moving object is performed.

Now, in terms of vehicle accessibility, a problem is to improve the vehicle accessibility such that an automatic door opening operation of automatically opening a vehicle door is executed by appropriately authenticating a user having a boarding intention while an unnecessary automatic door opening operation of the vehicle door is prevented when, for example, a user having no boarding intention simply stays around the vehicle for a work or the like.

To solve the aforementioned problem, the present application is directed to improving the vehicle accessibility such that an automatic door opening operation of automatically opening a vehicle door is executed by appropriately authenticating a user having a boarding intention while an unnecessary automatic opening operation of the vehicle door is prevented when a user having no boarding intention stays around the vehicle. Further, ultimately, the present application contributes to development of a sustainable transportation system.

### SUMMARY OF THE INVENTION

One aspect of the present invention is an entry system including: an acquisition section that acquires, assuming a person present in a surrounding of a vehicle as a target person, a target person image that is an image of the target person; an authentication section that performs authentication of the target person as a registered user having a usage right of the vehicle, based on the target person image; and a door control section that causes a door control device to execute automatic door unlocking and automatic door opening operation of a vehicle door under a condition in which the authentication succeeds, the door control device being configured to control locking/unlocking and opening/closing operation of the vehicle door of the vehicle, in which when a predetermined transitioning condition is satisfied, the door control section prohibits predetermined operation related to the automatic door opening operation during a temporary suspension period until a predetermined cancelling condition is satisfied, regardless of a result of the authentication.

Another aspect of the present invention is a door control method including the steps of: acquiring, assuming a person present in a surrounding of a vehicle as a target person, a target person image that is an image of the target person; performing authentication of the target person as a registered user having a usage right of the vehicle, based on the target person image; and controlling a door to cause a door control device to execute automatic door unlocking and automatic door opening operation of a vehicle door under a condition in which the authentication succeeds, the door control device being configured to control locking/unlocking and opening/closing operation of the vehicle door of the vehicle, in which in the controlling the door, when a predetermined transitioning condition is satisfied, predetermined operation related to the automatic door opening operation is prohibited during a temporary suspension period until a predetermined cancelling condition is satisfied, regardless of a result of the authentication.

According to an aspect of the present invention, it is possible to improve the vehicle accessibility such that an automatic door opening operation is executed by appropriately authenticating a user having a boarding intention while an unnecessary automatic door opening operation of the vehicle door is prevented when a user having no boarding intention stays around the vehicle.

### BRIEF DESCRIPTION OF THE DRAWINGS

FIG. 1 is a view showing an example of the configuration of a vehicle on which an entry system according to one embodiment of the present invention is mounted;

FIG. 2 is a view showing an example of the configuration inside a cabin;

FIG. 3 is a view showing the configuration of the entry system;

FIG. 4 is a view for explaining detection operation of a target person approaching a mobile body; and

FIG. 5 is a flowchart showing procedures of operation in the entry system.

### DETAILED DESCRIPTION OF THE INVENTION

Hereinafter, an embodiment of the present invention will be described with reference to the drawings.

### 1. Configuration of Vehicle

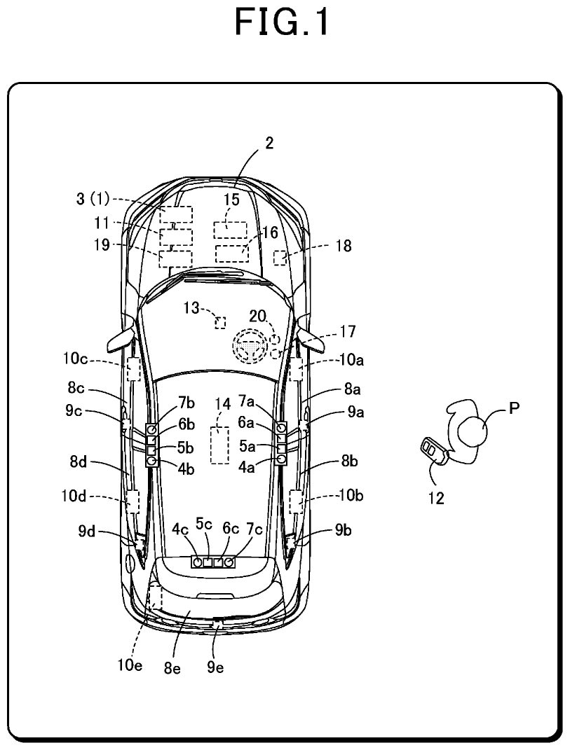

FIG. 1 is a view showing the configuration of a vehicle 2 on which an entry system 1 of the present embodiment is mounted. The vehicle 2 includes an entry control device 3 that constitutes the entry system 1. The entry system 1 is mounted on the vehicle 2, and performs authentication of a target person P who is any person trying to make an entry to the vehicle 2 and allows the target person P to use the vehicle 2 when the target person P can be authenticated as a person who has an authorized usage right of the vehicle 2. Here, the “entry” to the vehicle 2 refers to embarking on the vehicle 2 at least from the outside of the vehicle 2, and may additionally include transitioning the vehicle 2 to be in a state in which the target person P can use the vehicle 2, such as turning on the power source of the vehicle 2 after boarding.

In the present embodiment, the vehicle 2 is, for example, an electric automobile, and travels by actuating a drive device 15 as a motor with a battery 14 included in the vehicle 2. The vehicle 2 may be, for example, a shared car that a plurality of persons can use in turn.

The vehicle 2 includes an object sensor device 4 that detects an object in the surrounding of the vehicle 2, a first camera device 5 and a second camera device 6 that capture an image of the surrounding of the vehicle 2, and an illuminator 7 that illuminates the surrounding of the vehicle 2.

In the present embodiment, the right side part of the vehicle 2 is provided with a right object sensor device 4a that detects an object present on the right side of the vehicle 2, a first right camera device 5a and a second right camera device 6a that photograph the right side of the vehicle 2, and a right illuminator 7a that illuminates the right side of the vehicle 2.

Further, the left side part of the vehicle 2 is provided with a left object sensor device 4b that detects an object present on the left side of the vehicle 2, a first left camera device 5b and a second left camera device 6b that photograph the left side of the vehicle 2, and a left illuminator 7b that illuminates the left side of the vehicle 2.

Furthermore, the rear part of the vehicle 2 is provided with a rear object sensor device 4c that detects an object present on the rear side of the vehicle 2, a first rear camera device 5c and a second rear camera device 6c that photograph the rear side of the vehicle 2, and a rear illuminator 7c that illuminates the rear side of the vehicle 2.

The object sensor device 4 may include a sensor body and a processing device that performs signal processing of a sensor signal output by the sensor body. The sensor body is, for example, a ranging sensor capable of detecting an object in the surrounding and measuring the distance to the object, and is a millimeter wave radar in the present embodiment. The sensor body included in the object sensor device 4 is not limited to a radar, and may be any ranging sensor capable of performing object detection and distance measurement. Such sensors may be, for example, a LiDar or a sonar in addition to a radar.

The second camera device 6 has a higher resolution and a higher power consumption as compared to the first camera device 5.

The first camera device 5 and the second camera device 6 may include, for example, a camera body composed of CCD cameras having different pixel counts and a processing device that performs operation control of the camera body and image processing of a captured image by the camera body.

The illuminator 7 may be configured using any light emitter or light emitting element. In the present embodiment, the illuminator 7 is, for example, an LED floodlight.

The vehicle 2 further includes an external operating unit 9 with which a person outside instructs the vehicle 2 to perform locking/unlocking of the vehicle door 8. The external operating unit 9 may be a touch sensor and/or a touch switch provided in a doorknob of the vehicle door 8 or a pillar around the vehicle door 8.

The vehicle 2 also includes a door control device 10 in each of the vehicle doors 8 as a door of the vehicle 2. The door control device 10 controls an actuator that performs locking/unlocking of the corresponding vehicle door 8 and an actuator that performs opening/closing of the vehicle door 8, thereby controlling locking/unlocking and opening/closing operation of the vehicle door 8. Specifically, the door control device 10 executes automatic door unlocking to automatically unlock the corresponding vehicle door 8 and automatic door opening operation to automatically open the corresponding vehicle door 8. Further, the door control device 10 executes automatic door locking to automatically lock the corresponding vehicle door 8 and automatic door closing operation to automatically close the corresponding vehicle door 8.

In the present embodiment, the vehicle 2 includes, as the external operating unit 9 and the door control device 10 that are provided in the vehicle door 8, an external operating unit 9a and a door control device 10a that are provided in a driver's door 8a on the front right side of the vehicle 2, and an external operating unit 9b and a door control device 10b that are provided in the rear right door 8b on the rear right side of the vehicle 2. Further, the vehicle 2 includes an external operating unit 9c and a door control device 10c that are provided in the passenger's door 8c on the front left side of the vehicle 2, and an external operating unit 9d and a door control device 10d that are provided in the rear left door 8d on the rear left side of the vehicle 2. The vehicle 2 further includes an external operating unit 9e and a door control device 10e that are provided in a rear gate (tailgate) 8e of the vehicle 2.

The vehicle 2 also includes a communication device 11. The communication device 11 includes a transceiver for communication with an electronic key 12 used in the use of the vehicle 2. The aforementioned electronic key 12 may be, for example, a smart key such as an FOB key or a mobile terminal such as a smartphone in which key information used in the use of the vehicle 2 is stored.

The vehicle 2 may further include, on the front side of the interior of the vehicle 2, an interior camera 13 that captures an image of the interior of the vehicle 2. The interior camera 13 may capture an image of the interior including a face of an operator seated on an operator's seat of the vehicle 2.

The vehicle 2 further includes a drive control device 16 that includes a processor and controls the operation of the drive device 15. Under the condition in which an operating permission is received from the entry control device 3, the drive control device 16 performs a preparation operation to operate the drive device 15 when a starting switch 17 included in the vehicle 2 is pressed. The preparation operation may include, for example, in accordance with the conventional technique, confirmation of the state and initialization of an inverter (not shown) included in the drive control device 16, a battery 14, and the drive device 15, and activation of the drive device 15 and a cooling system (not shown) of the aforementioned inverter. After completion of the preparation operation, the drive control device 16, in accordance with the conventional technique, controls the operation of the drive device 15 to cause the vehicle 2 to travel, following a driving operation performed by a manipulating/operating unit such as an acceleration pedal (not shown).

The vehicle 2 also includes a wheel rotation sensor 18 that detects the wheel speed of the vehicle 2.

In the present embodiment, in particular, the vehicle 2 includes a temporary suspension switch 20 for instructing the entry control device 3 to perform temporary suspension of the automatic door opening operation by the door control device 10. An input from the temporary suspension switch 20 is transmitted to the entry control device 3 via a driver's seat management device 19. The driver's seat management device 19 may be, for example, a cockpit domain controller (CDC, Cockpit Domain Controller) that includes a processor and that integrates and manages the operations of electronic equipment arranged around the driver's seat.

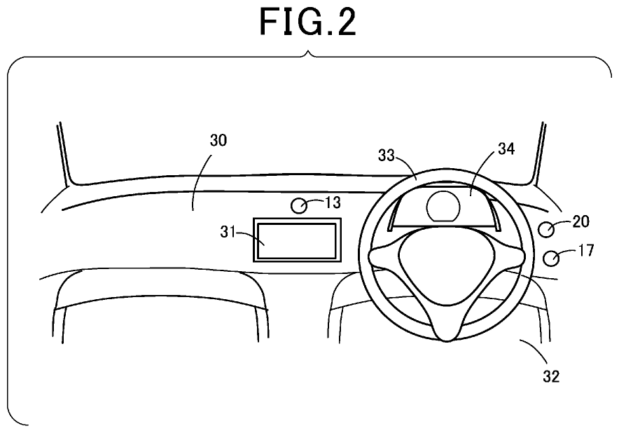

FIG. 2 is a view showing an example of the configuration of the front side of a cabin of the vehicle 2. In the cabin of the vehicle 2, a touch panel 31 and the interior camera 13 are disposed at the center in the vehicle width direction of an instrument panel 30. The touch panel 31, in accordance with the conventional technique, displays a map for route guidance, switches for air conditioner setting, and the like. Inside the cabin, at a front side position of the driver's seat 32 of the instrument panel 30, a meter display device 34, the starting switch 17, and the temporary suspension switch 20 are disposed. The meter display device 34 may be, for example, a Multi-Information Display (MID). The starting switch 17 and the temporary suspension switch 20 are, for example, a pushbutton physical switch. The operations of the touch panel 31 and the meter display device 34 are controlled by, for example, the driver's seat management device 19.

The temporary suspension switch 20 may be configured as a steering switch disposed in a steering wheel spoke or the like of a steering wheel 33 on the front side of the driver's seat 32. Alternatively, the temporary suspension switch 20 may be a physical touch switch provided in the touch panel 31 or the meter display device 34.

### 2. Configuration of Entry System

The configuration of the entry system 1 will be described.

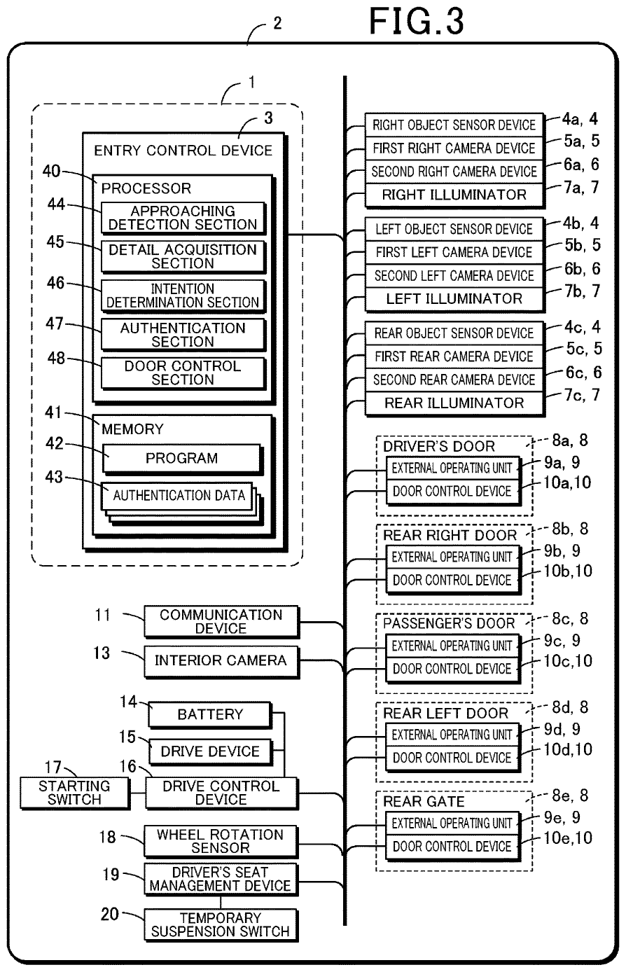

FIG. 3 is a view showing the configuration of the entry system 1. The entry system 1 includes at least the entry control device 3. The entry system 1 may include all or part of other devices and equipment shown in FIG. 3, such as the object sensor device 4, the first camera device 5, and the second camera device 6 that the entry control device 3 uses.

The entry control device 3 performs authentication of a target person P who is any person trying to make an entry to the vehicle 2 and allows the target person P to use the vehicle 2 when the target person P can be authenticated. The aforementioned authentication is performed by matching acquired individual data of the target person P and authentication data of a registered user stored in a storage device in advance.

Note that hereafter, the “target person” refers to a person as a target of authentication by the entry system 1. Further, the “user” refers to a registered user who is registered in advance as a person who has an authorized right for the use of the vehicle 2 and a person who actually uses the vehicle 2. The target person P becomes a user when authenticated by the entry control device 3 to become eligible for the use of the vehicle 2.

In the present embodiment, the individual data of the target person P acquired for authentication and the authentication data are a facial image of the target person P and a facial image of a registered user, respectively.

Part of functional elements of the entry control device 3 shown below may be included in another device. For example, a door control section 48 (described later) included in the entry control device 3 may be implemented as a functional element of another electronic control unit (ECU) that controls the operation of the vehicle 2. In this case, the entry system 1 includes at least the entry control device 3 and the aforementioned electronic control unit, and the entry control device 3, through communication with the aforementioned electronic control unit, can cause the electronic control unit to execute the function of the door control section 48.

The entry control device 3 is a computer including a processor 40 and a memory 41. The memory 41 is configured with, for example, a volatile and/or nonvolatile semiconductor memory and/or a hard disc device. The memory 41 stores authentication data 43 including a facial image of one or each of a plurality of registered users registered in advance as a person who has an authorized right for the use of the vehicle 2.

The processor 40 is, for example, a computing processing device, such as a CPU. The processor 40 may be configured with a ROM in which programs are written, a RAM for temporarily storing data, and the like. Further, the processor 40 includes, as functional elements or functional units, an approaching detection section 44, a detail acquisition section 45, an intention determination section 46, an authentication section 47, and the door control section 48.

These functional elements included in the processor 40 are implemented by, for example, the processor 40 executing a program 42 stored in the memory 41. Note that the program 42 may be stored in any computer-readable storage medium. Alternatively, all or part of the aforementioned functional elements included in the processor 40 may also be configured with pieces of hardware each including one or more electronic circuit components.

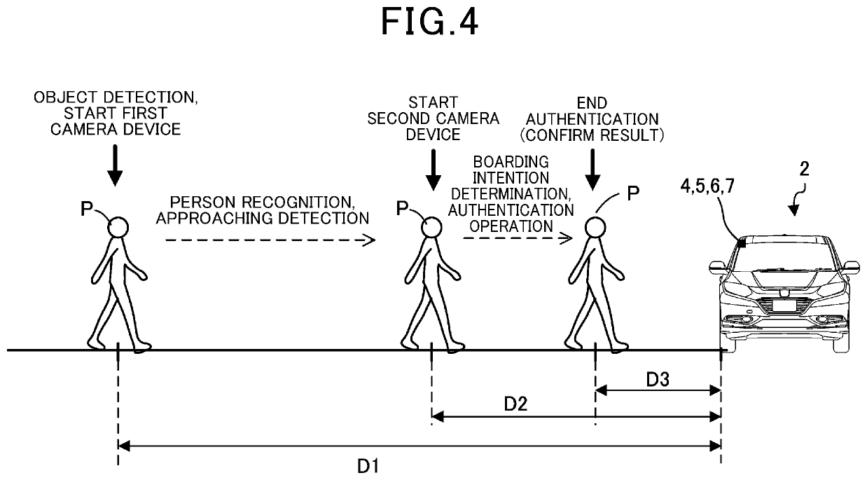

The approaching detection section 44 detects the target person P approaching the vehicle 2, using the object sensor device 4 and the first camera device 5. The approaching detection section 44 operates, for example, as shown in FIG. 4. FIG. 4 is an explanatory view for explaining the operation of the approaching detection section 44.

The approaching detection section 44, first, determines, using the object sensor device 4, whether an entity has entered a range of a preset predetermined distance D1 from the vehicle 2. The entity may be any object including a living and a non-living object. The approaching detection section 44 starts the first camera device 5 close to the object sensor device 4 that has detected the entity, when the entity has entered the range of the predetermined distance D1.

The approaching detection section 44 continuously acquires, using the started first camera device 5, a first image of the surrounding of the vehicle 2 at a predetermined time interval. The approaching detection section 44 performs image recognition processing of the first image photographed by the first camera 5 and determines whether the entity is a person. When the entity is a person, the approaching detection section 44 determines whether the person is approaching the vehicle 2, based on the first image continuously photographed by the first camera device 5. When the aforementioned person is approaching the vehicle 2, the approaching detection section 44 determines that the person is the target person P. Thus, the approaching detection section 44 detects the target person P approaching the vehicle 2. When the target person P was detected, the approaching detection section 44 notifies the detail acquisition section 45 of the detection. In an example shown in FIG. 4, while the entity detected by the object sensor device 4 advances to a position of a distance D2 from the vehicle 2, the approaching detection section 44 determines that the entity is a person approaching the vehicle 2, and when the person reaches the position of the distance D2, notifies the detail acquisition section 45 of the target person P having been detected.

The detail acquisition section 45 acquires a second image as an image of the target person P who has approached the surrounding of the vehicle 2. The detail acquisition section 45 also extracts and acquires a facial image of the target person P from the second image each time the second image of the target person P is photographed. Here, the detail acquisition section 45 and the facial image of the target person P extracted from the second image correspond to the acquisition section and the target person image in the present disclosure, respectively.

When the approaching detection section 44 detects the target person P, the detail acquisition section 45 starts the second camera device 6 close to the first camera device 5 that was used for the detection of the target person P and acquires, at a predetermined time interval, the second image of the target person P using the started second camera device 6. In starting the second camera device 6, the detail acquisition section 45 may turn on the illuminator 7 close to the aforementioned started second camera device 6 when the surrounding of the vehicle 2 is dark.

As described above, the second camera device 6 has a higher resolution and a higher power consumption as compared to the first camera device 5.

The detail acquisition section 45 continuously photographs, using the started second camera device 6, a high-definition second image of the target person P at the predetermined time interval. The detail acquisition section 45 extracts the facial image of the target person P from the second image each time the second image of the target person P is photographed and acquires a plurality of facial images of the target person P captured at the predetermined time interval. The detail acquisition section 45 transmits, to the intention determination section 46 and the authentication section 47, the image of the photographed target person P and the aforementioned extracted facial image each time the second image of the target person P is photographed.

The intention determination section 46 determines the presence or absence of an intention of boarding the vehicle 2 by the target person P, based on the movement of the target person P recognized from the plurality of second images captured at the aforementioned predetermined time interval. For example, the intention determination section 46 may determine that the target person P has an intention of boarding the vehicle 2 when the target person P is further approaching any of the vehicle doors 8 of the vehicle 2, the target person P stops in front of any of the vehicle doors 8 of the vehicle 2, or the target person P extends his/her hand toward a doorknob of any of the vehicle doors 8.

In the example shown in FIG. 4, for example, the intention determination section 46 determines the presence or absence of a boarding intention of the target person P at a position of a distance D3 from the vehicle 2.

The intention determination section 46 notifies the authentication section 47 of the determination result of the presence or absence of an intention of boarding the vehicle 2 by the target person P.

The authentication section 47 performs authentication of the target person P as a registered user having a usage right of the vehicle 2, from the facial image of the target person P as the target person image acquired by the detail acquisition section 45. The authentication section 47, for example, matches the facial image of the target person P acquired by the detail acquisition section 45 with the facial image contained in the authentication data 43 of the registered user recorded in the memory 41. In this manner, the authentication section 47 performs authentication of the target person P as a registered user, based on the aforementioned acquired facial image of the target person P.

As described above, since the detail acquisition section 45 transmits the image and the facial image of the photographed target person P to the authentication section 47 each time the second image of the target person P is photographed, the authentication section 47 can perform the authentication of the target person P while concurrently acquiring the second image by the detail acquisition section 45. For example, in the example of FIG. 4, the authentication section 47 may operate so as to complete the authentication of the target person P at the position of the distance D3 where the intention determination section 46 completes the determination on the presence or absence of a boarding intention of the target person P.

Specifically, the authentication section 47 calculates the feature amounts of the facial image acquired by the detail acquisition section 45 and calculates, for each registered user, matching scores indicating the degree of matching between the calculated feature amounts (hereinafter, target feature amounts) and the feature amounts (hereinafter, feature amounts for authentication) of a facial image stored in the authentication data 43 of each registered user stored in the memory 41.

Then, the authentication section 47 determines whether the target person P is any registered user, based on the aforementioned calculated matching scores. Specifically, for example, when there are matching scores that are equal to or greater than a first predetermined value in the aforementioned calculated matching scores, the authentication section 47 authenticates the target person P as a registered user corresponding to the matching score indicating the highest value among the matching scores that are equal to or greater than the first predetermined value. Thus, the authentication of the target person P succeeds.

Meanwhile, when there is no matching score that is equal to or greater than the first predetermined value in the aforementioned calculated matching scores, the authentication section 47 determines that the target person P is not a registered user. Thus, the authentication of the target person P fails.

Here, the authentication section 47 may calculate the aforementioned matching scores for each of the plurality of facial images of the target person P extracted from each of the plurality of images acquired by the detail acquisition section 45 at the predetermined time interval to determine whether there is a registered user corresponding to the target person P based on the calculated matching scores. In this case, when the registered user corresponding to the target person P determined for each of the aforementioned plurality of facial images is one and the same registered user at a probability equal to or higher than a predetermined value in the aforementioned plurality of facial images, the authentication section 47 may determine that the target person P is the aforementioned one and the same registered user. When the aforementioned one and the same registered user cannot be identified, the authentication section 47 can determine that the target person P is not a registered user.

Note that in the aforementioned description, the distance D1, D2, D3 is not necessarily a preset distance, and the detection of the entity and detection of the target person by the approaching detection section 44, the acquisition of the second image by the detail acquisition section 45, the determination on a boarding intention by the intention determination section 46, and the authentication of the target person P by the authentication section 47 may be a series of processing.

For example, the distance D1 may be the maximum distance at which the object sensor device 4 can detect an entity. Further, the distance D2 may be defined by the aforementioned distance D1, the moving speed of a person as an entity, and the time required for recognition of a person by the approaching detection section 44. Furthermore, for example, the distance D3 may be defined by the aforementioned distances D1 and D2, the moving speed of the target person P, and the time required for the determination on a boarding intention of the target person P by the intention determination section 46 and/or the time required for the authentication of the target person P by the authentication section 47.

In performing the authentication of the target person P, the authentication section 47 may perform so-called liveness determination as to whether the facial image of the target person P acquired from the second image is the image of the photographed actual face of the target person P him/herself. In the liveness determination, when it is determined that the aforementioned acquired facial image is not the image of the photographed actual face of the target person P him/herself, such as an image of a part of the head of a third person on which a mask with a facial photograph printed is put, for example, the authentication section 47 may determine that the authentication using the facial image has failed.

Specifically, for example, under the conditions in which a hue of each facial image extracted from each of the plurality of images continuously captured by the detail acquisition section 45 from the second camera device 6 at the predetermined time interval and/or a change in chronological brightness distribution of the aforementioned facial image satisfy preset criteria, the authentication section 47 can perform the authentication of the target person P as a registered user, based on the facial images. Here, the aforementioned criteria may include, for example, a tone of color of the facial image that is not a tone of color unique to a printed matter, and/or the illumination on the face of the target person P identified from the aforementioned plurality of chronological facial images continuously changing with consistency.

As a result, for example, an attempt by the target person P to falsely make an entry to the vehicle 2 by wearing a mask on which a facial image of another registered user is printed can be effectively prevented.

The authentication section 47 may perform the authentication of the target person P as a registered user when the intention determination section 46 determines that the target person P has an intention of boarding the vehicle 2. As a result, the authentication section 47 can be prevented from performing unnecessary authentication of a person who is not intending to board the vehicle 2 as the target person P.

Further, based on the plurality of images continuously captured by the detail acquisition section 45 using the second camera device 6 at the predetermined time interval, the authentication section 47 may perform the authentication of the target person P as a registered user under the condition in which a gesture performed by the target person P corresponds to a preregistered gesture for authentication. The gesture for authentication may be, for example, composed of the chronological images acquired from a preregistered user and stored in the memory 41.

In this manner, also based on the gesture of the target person P, the authentication of the target person P can be more appropriately performed.

The authentication section 47 also authenticates the target person P in response to the operation performed on the external operating unit 9 that is provided around the vehicle door 8 on an outside of the vehicle 2. In this case, since it is evident that the target person P has a boarding intention or the target person P requires locking/unlocking the vehicle door 8, the authentication section 47 can perform the authentication operation of the target person P without waiting the determination by the intention determination section 46. In this case, the authentication section 47 may instruct the detail acquisition section 45 to acquire the second image of the target person P using the second camera device 6 and to extract the facial image of the target person P from the second image.

The authentication section 47 also starts the interior camera 13 when the target person P can be authenticated as a registered user. The authentication section 47 then assumes a person to be seated on the driver's seat 32 as a driver and performs driver authentication as to whether the driver is a registered user. The driver authentication also can be performed, similarly to the aforementioned authentication of the target person P, by matching a facial image of the driver acquired by the interior camera 13 with the authentication data 43 of a registered user recorded in the memory 41. Alternatively, the driver authentication may be performed using other publicly-known authentication techniques, such as fingerprint authentication and voice authentication.

When the driver authentication succeeds, the authentication section 47 transmits an operating permission to the drive control device 16.

Further, under the condition in which the authentication of the target person P by the authentication section 47 succeeds, the door control section 48 causes the door control device 10 of the vehicle 2 to execute automatic door unlocking and automatic door opening operation of the corresponding vehicle door 8. The door control section 48 executes, for example, the automatic door unlocking and the automatic door opening operation targeting the vehicle door 8 closest to the target person P. The detail acquisition section 45 identifies the vehicle door 8 closest to the target person P from the second image most recently acquired, for example, of which the door control section 48 can be notified.

In the present embodiment, in particular, when a predetermined transitioning condition is satisfied, the door control section 48 prohibits predetermined operation related to the automatic door opening operation of all or part of the vehicle doors 8 for a temporary suspension period until a predetermined cancelling condition is satisfied. As a result, a registered user having a boarding intention is appropriately authenticated and the automatic door opening operation is executed while unnecessary automatic door opening operation of the vehicle door 8 is prevented by defining in advance, as the transitioning condition, occasions that may not require the automatic door opening operation, so that the vehicle accessibility can be improved.

The aforementioned transitioning condition includes the temporary suspension switch 20 having been operated, the temporary suspension switch 20 being an input device provided inside the cabin of the vehicle 2. In this manner, since an explicit instruction from the user can be provided through the pressing operation of the temporary suspension switch 20 by the user of the vehicle 2, unnecessary automatic door opening operation of the vehicle door 8 can be surely prevented.

Further, the aforementioned transitioning condition may include the target person P having been detected in the surrounding of the vehicle 2 a plurality of times after the vehicle door 8 is closed. In this manner, when the registered user simply stays around the vehicle for, for example, vehicle washing work with no boarding intention, unnecessary automatic door opening operation of the vehicle door is prevented, so that the vehicle accessibility can be improved. Note that whether the target person P has been detected in the surrounding of the vehicle 2 a plurality of times is determined by the approaching detection section 44 based on the first image from the first camera device 5, of which the door control section 48 can be notified.

The predetermined operation related to the automatic door opening operation prohibited by the door control section 48 when the aforementioned transitioning condition is satisfied may include at least one of the operation related to the acquisition of the target person image by the detail acquisition section 45, the operation related to the authentication of the target person P by the authentication section 47, or the automatic door opening operation by the door control device 10. In this manner, during the temporary suspension period, the processing or operation of various functional sections or devices related to the vehicle entry can be halted so as not to perform the automatic door opening operation, so that unnecessary power consumption of the vehicle 2 can be prevented.

Here, the aforementioned “operation related to the acquisition of the target person image by the detail acquisition section 45” may include, for example, image capturing operation by the second camera device 6, facial image acquisition operation by the detail acquisition section 45, operation of outputting the facial image to the authentication section 47, and processing of detecting the target person P by the approaching detection section 44 as a preceding stage.

The aforementioned cancelling condition (that is, the condition for ending the temporary suspension period) includes the movement of the vehicle 2 having been started. In this manner, since the temporary suspension period automatically ends upon the registered user having boarded and the movement of the vehicle 2 having been started, the accessibility of the vehicle 2 can be further improved. Note that the movement of the vehicle 2 having been started can be detected from sensor information from the wheel rotation sensor 18.

Further, the cancelling condition may include the speed of the vehicle 2 having exceeded a preset threshold speed, the drive control device 16 of the vehicle 2 having completed the preparation operation to operate the drive device 15, or the temporary suspension switch 20 as the input device having been pressed again, the input device being provided inside the cabin of the vehicle 2. In this manner, upon the start of the use of the vehicle 2, the temporary suspension period is automatically cancelled or with an explicit operation input by the vehicle user, the temporary suspension period is surely cancelled, so that the vehicle accessibility can be further improved.

Further, the cancelling condition includes a preset limit time having elapsed from the time when the transitioning condition is satisfied. In this manner, the temporary suspension period started upon satisfaction of the transitioning condition is prevented from continuing for unnecessarily long period of time and the normal vehicle entry is available upon the start of the next use of the vehicle 2, so that the vehicle accessibility can be improved.

Note that the aforementioned limit time may be changed by the user of the vehicle 2. The user may be able to input a change value for the upper limit time into the entry control device 3 via the touch panel 31, for example.

Further, when the authentication section 47 authenticates the target person P in response to the operation performed on the external operating unit 9 that is provided on the outside of the vehicle 2, the door control section 48 may instruct the door control device 10 to perform the automatic door unlocking of the vehicle door 8 even in the middle of the temporary suspension period. In this manner, the user of the vehicle 2 can quickly board the vehicle 2 by operating the external operating unit 9 even during the temporary suspension period.

Note that when a request for operating the vehicle door 8 is received from the electronic key 12 via the communication device 11, regardless of whether the authentication section 47 has authenticated the target person P or the temporary suspension period of the automatic door opening operation has started, the door control section 48, in accordance with the conventional technique, executes the operation designated by these operation requests when the legitimacy of the electronic key 12 can be authenticated. For example, when a request for unlocking or a request for locking the vehicle door 8 is received from the legitimate electronic key 12, the door control section 48 unlocks or locks the vehicle door 8 designated by these requests. Further, when a request for opening operation or closing operation of the vehicle door 8 is received from the legitimate electronic key 12, the door control section 48 executes the automatic door opening operation or the automatic door closing operation of the vehicle door 8 designated by these requests.

### 3. Operation of Entry System

Next, the procedures of the operation of the entry system 1 will be described.

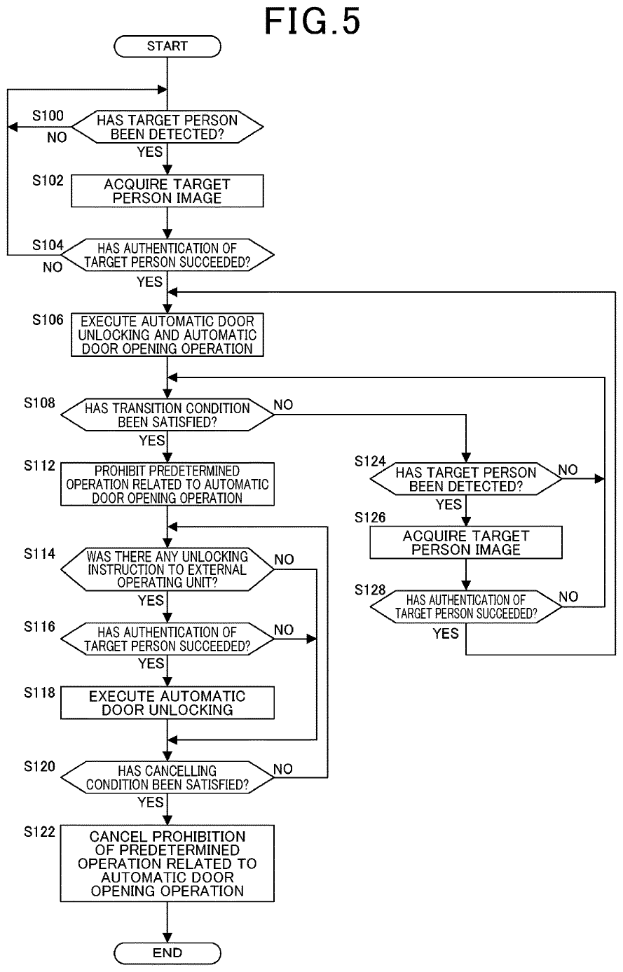

FIG. 5 is a flowchart showing the procedures of a door control method executed by a computer of the entry system 1. Each step shown in FIG. 5 is executed by the processor 40 of the entry control device 3 as a computer of the entry system 1.

The processing shown in FIG. 5 starts when a power source of each piece of equipment shown in FIG. 3 including the entry control device 3 is turned on, and is repeatedly executed.

Upon the start of the processing, first, when the object sensor device 4 has detected an entity in the surrounding of the vehicle 2, the approaching detection section 44 of the entry control device 3 acquires the first image as the image of the surrounding of the vehicle 2 using the first camera device 5 to determine whether the target person P approaching the vehicle 2 has been detected (S100). Then, when the target person P is not detected (S100, NO), the approaching detection section 44 returns to step S100 and repeats the detection operation of the target person P.

Meanwhile, when the approaching detection section 44 has detected the target person P approaching the vehicle 2 (S100, YES), the detail acquisition section 45 photographs the second image of the target person P using the second camera device 6 to acquire the target person image from the second image (S102). In the present embodiment, the target person image is a facial image.

Next, when the authentication section 47 performs authentication of the target person P as a registered user, from the target person image acquired by the detail acquisition section 45, and when the target person P cannot be authenticated as a registered user, that is, the authentication fails (S104, NO), the authentication section 47 returns the processing to step S100.

Meanwhile, when the authentication section 47 determines that the target person P is a registered user, that is, the authentication succeeds (S104, YES), the door control section 48 causes the door control device 10 to execute the automatic door unlocking and the automatic door opening operation of the vehicle door 8 (S106).

Subsequently, the door control section 48 determines whether the predetermined transitioning condition has been satisfied (S108). As described above, the transitioning condition may include the temporary suspension switch 20 having been operated, the temporary suspension switch 20 being the input device provided inside the cabin of the vehicle 2 and/or the target person P having been detected in the surrounding of the vehicle 2 a plurality of times.

Further, when the transitioning condition is not satisfied (S108, NO), the entry control device 3 waits the transitioning condition to be satisfied while repeating the search and authentication of another target person P outside the vehicle 2. That is, the approaching detection section 44 determines, based on the first image from the first camera device 5, whether another target person P approaching the vehicle 2 has been detected (S124). Then, when the target person P is not detected (S124, NO), the approaching detection section 44 returns the processing to step S108.

Meanwhile, when the target person P has been detected (S124, YES), the detail acquisition section 45 acquires the target person image from the second image taken by the second camera device 6 (S126). The authentication section 47 performs authentication of the target person P as a registered user, using the target person image, and when the target person P cannot be authenticated as a registered user, that is, the authentication fails (S128, NO), the authentication section 47 returns the processing to step S108.

Meanwhile, when the authentication section 47 can authenticate the target person P as a registered user, that is, the authentication succeeds (S128, YES), the authentication section 47 returns the processing to step S106.

Meanwhile, when the transitioning condition is satisfied in step S108 (S108, YES), the door control section 48 prohibits the predetermined operation related to the automatic door opening operation (S112). As described above, the aforementioned predetermined operation may include at least one of the operation related to the acquisition of the target person image by the detail acquisition section 45, the operation related to the authentication of the target person P by the authentication section 47, or the automatic door opening operation by the door control device 10.

Next, the authentication section 47 determines whether there was any operation of an unlocking instruction to the external operating unit 9 provided in the surrounding of the vehicle door 8 (S114). Then, when there was an operation of the external operating unit 9 (S114, YES), the authentication section 47 acquires the target person image photographed by the second camera device 6 from the detail acquisition section 45 and performs the authentication of the target person P who has operated the external operating unit 9 as a registered user. Then, when it is determined that the target person P who has operated the external operating unit 9 is a registered user, that is, the authentication of the target person P succeeds (S116, YES), the door control section 48 instructs the door control device 10 to execute the automatic door unlocking (S118).

Subsequently, the door control section 48 determines whether the cancelling condition has been satisfied (S120). As described above, the cancelling condition may include the movement of the vehicle 2, an increase in the vehicle speed exceeding a threshold speed, completion of the preparation operation by the drive control device 16, the temporary suspension switch 20 being pressed again, and/or elapse of a time exceeding the upper limit time after the transitioning condition is satisfied.

Further, when the cancelling condition is not satisfied (S120, NO), the door control section 48 returns the processing to step S114. Meanwhile, when the cancelling condition has been satisfied (S120, NO), the door control section 48 cancels the prohibition of the predetermined operation related to the automatic door opening operation prohibited in step S112 (S122), and ends the present processing. After ending the present processing, new processing starts from step S100.

Meanwhile, when there is no operation of an unlocking instruction to the external operating unit 9 in step S114 (S114, NO) or the authentication of the target person P does not succeed in step S116 (S116, NO), the authentication section 47 transfers the processing to step S120.

In FIG. 5, step S102 and S104 correspond to the acquisition step and the authentication step of the present disclosure, respectively. Further, the processing from step S106 to S122 corresponds to the door control step in the present disclosure.

### 4. Other Embodiments

The transitioning condition may include, in addition to those described above, the presence of a voice instruction of a predetermined phrase by the target person P as a registered user or a predetermined gesture performed by the target person P as a registered user. The entry control device 3 may include a voice recognition section and an image analysis section, in accordance with the conventional technique, which respectively perform identification of a speaker of the voice acquired by a microphone (not shown) inside the cabin and analysis of the speech content, and gesture recognition through analysis of the image from the interior camera 13.

The door control section 48 may execute the automatic door closing operation and the automatic door locking of the vehicle door 8 after the user of the vehicle 2 opens the vehicle door 8 and gets off the vehicle. For example, the door control section 48 can execute the automatic door closing operation and the automatic door locking of the vehicle door 8 when as a sequence of getting off the vehicle, the user moves in a direction leaving away from the vehicle 2 after getting off the vehicle 2 to be away from the vehicle 2 by a predetermined distance or farther. In this case, for the sequence of getting off the vehicle, during the temporary suspension period, the door control section 48 may prohibit the automatic door locking and execute only the automatic door closing operation.

Note that the present invention is not limited to the configurations of the aforementioned embodiments, and can be implemented in various aspects within the range without departing from the gist of the present invention.

### 5. Configurations Supported by Aforementioned Embodiments

The aforementioned embodiments support the following configurations.

(Configuration 1) An entry system including: an acquisition section that acquires, assuming a person present in a surrounding of a vehicle as a target person, a target person image that is an image of the target person; an authentication section that performs authentication of the target person as a registered user having a usage right of the vehicle, based on the target person image; and a door control section that causes a door control device to execute automatic door unlocking and automatic door opening operation of a vehicle door under a condition in which the authentication succeeds, the door control device being configured to control locking/unlocking and opening/closing operation of the vehicle door of the vehicle, in which when a predetermined transitioning condition is satisfied, the door control section prohibits predetermined operation related to the automatic door opening operation during a temporary suspension period until a predetermined cancelling condition is satisfied, regardless of a result of the authentication.

According to Configuration 1, a registered user having a boarding intention is appropriately authenticated to execute the automatic door opening operation while unnecessary automatic door opening operation of the vehicle door is prevented by defining in advance, as the transitioning condition, occasions that may not require the automatic door opening operation, so that the vehicle accessibility can be improved.

(Configuration 2) The entry system according to Configuration 1, in which the transitioning condition includes an input device having been operated, the input device being provided inside a cabin of the vehicle.

According to Configuration 2, since an explicit instruction from the user can be provided through the operation of the input device by the user of the vehicle, unnecessary automatic door opening operation of the vehicle door can be surely prevented.

(Configuration 3) The entry system according to Configuration 1 or 2, in which the transitioning condition includes the target person having been detected in the surrounding of the vehicle a plurality of times after the vehicle door is closed.

According to Configuration 3, when the registered user simply stays around the vehicle for, for example, vehicle washing work with no boarding intention, unnecessary automatic door opening operation of the vehicle door is prevented, so that the vehicle accessibility can be improved.

(Configuration 4) The entry system according to any one of Configurations 1 to 3, in which the cancelling condition includes movement of the vehicle having been started.

According to Configuration 4, since the temporary suspension period automatically ends upon the registered user having boarded and the movement of the vehicle having been started, the vehicle accessibility can be further improved.

(Configuration 5) The entry system according to any one of Configurations 1 to 4, in which the cancelling condition includes: a speed of the vehicle having exceeded a preset threshold speed; a drive control device having completed preparation operation to operate a drive device, the drive control device being configured to control the drive device of the vehicle; or an input device having been operated again, the input device being provided inside a cabin of the vehicle.

According to Configuration 5, with the start of the use of the vehicle, the temporary suspension period is automatically cancelled or with an explicit input by the vehicle user, the temporary suspension period is surely cancelled, so that the vehicle accessibility can be further improved.

(Configuration 6) The entry system according to any one of Configurations 1 to 5, in which the cancelling condition includes a preset limit time having elapsed from a time when the transitioning condition is satisfied.

According to Configuration 6, the temporary suspension period started upon satisfaction of the transitioning condition is prevented from continuing for unnecessarily long period of time and the normal vehicle entry is available upon the start of the next use of the vehicle, so that the vehicle accessibility can be improved.

(Configuration 7) The entry system according to any one of Configurations 1 to 6, in which the predetermined operation related to the automatic door opening operation prohibited by the door control section when the transitioning condition is satisfied includes at least one of operation related to acquisition of the target person image by the acquisition section, operation related to the authentication by the authentication section, or the automatic door opening operation by the door control device.

According to Configuration 7, during the temporary suspension period, the processing or operation of various functional sections or devices related to the vehicle entry can be halted so as not to perform the automatic door opening operation, so that unnecessary power consumption of the vehicle 2 can be prevented.

(Configuration 8) The entry system according any one of Configurations 1 to 6, in which when the authentication section authenticates the target person in response to operation performed on an external operating unit that is provided on an outside of the vehicle, the door control section instructs the door control device to perform the automatic door unlocking of the vehicle door even in a middle of the temporary suspension period.

According to Configuration 8, the user of the vehicle 2 can quickly board the vehicle 2 by operating the external operating unit 9 even during the temporary suspension period.

(Configuration 9) A door control method including the steps of: acquiring, assuming a person present in a surrounding of a vehicle as a target person, a target person image that is an image of the target person; performing authentication of the target person as a registered user having a usage right of the vehicle, based on the target person image; and controlling a door to cause a door control device to execute automatic door unlocking and automatic door opening operation of a vehicle door under a condition in which the authentication succeeds, the door control device being configured to control locking/unlocking and opening/closing operation of the vehicle door of the vehicle, in which in the controlling the door, when a predetermined transitioning condition is satisfied, predetermined operation related to the automatic door opening operation is prohibited during a temporary suspension period until a predetermined cancelling condition is satisfied, regardless of a result of the authentication.

According to Configuration 9, the same advantageous effects as those of Configuration 1 are produced.

### REFERENCE SIGNS LIST

1 entry system
2 vehicle
3 entry control device
4 object sensor device
4a right object sensor device
4b left object sensor device
4c rear object sensor device
5 first camera device
5a first right camera device
5b first left camera device
5c first rear camera device
6 second camera device
6a second right camera device
6b second left camera device
6c second rear camera device
7 illuminator
7a right illuminator
7b left illuminator
7c rear illuminator
8 vehicle door
8a driver's door
8b rear right door
8c passenger's door
8d rear left door
8e rear gate
9, 9a, 9b, 9c, 9d, 9e external operating unit
10, 10a, 10b, 10c, 10d, 10e door control device
11 communication device
12 electronic key
13 interior camera
14 battery
15 drive device
16 drive control device
17 starting switch
18 wheel rotation sensor
19 driver's seat management device
20 temporary suspension switch
30 instrument panel
31 touch panel
32 driver's seat
33 steering wheel
34 meter display device
40 processor
41 memory
42 program
43 authentication data
44 approaching detection section
45 detail acquisition section
46 intention determination section
47 authentication section
48 door control section

1. An entry system comprising:
an acquisition section that acquires, assuming a person present in a surrounding of a vehicle as a target person, a target person image that is an image of the target person;
an authentication section that performs authentication of the target person as a registered user having a usage right of the vehicle, based on the target person image; and
a door control section that causes a door control device to execute automatic door unlocking and automatic door opening operation of a vehicle door under a condition in which the authentication succeeds, the door control device being configured to control locking/unlocking and opening/closing operation of the vehicle door of the vehicle,
wherein when a predetermined transitioning condition is satisfied, the door control section prohibits predetermined operation related to the automatic door opening operation during a temporary suspension period until a predetermined cancelling condition is satisfied, regardless of a result of the authentication.

2. The entry system according to claim 1, wherein the transitioning condition comprises an input device having been operated, the input device being provided inside a cabin of the vehicle.

3. The entry system according to claim 1, wherein the transitioning condition comprises the target person having been detected in the surrounding of the vehicle a plurality of times after the vehicle door is closed.

4. The entry system according to claim 1, wherein the cancelling condition comprises movement of the vehicle having been started.

5. The entry system according to claim 1, wherein the cancelling condition comprises:
a speed of the vehicle having exceeded a preset threshold speed;
a drive control device having completed preparation operation to operate a drive device, the drive control device being configured to control the drive device of the vehicle; or
an input device having been operated again, the input device being provided inside a cabin of the vehicle.

6. The entry system according to claim 1, wherein the cancelling condition comprises a preset limit time having elapsed from a time when the transitioning condition is satisfied.

7. The entry system according to claim 1, wherein the predetermined operation related to the automatic door opening operation prohibited by the door control section when the transitioning condition is satisfied comprises at least one of operation related to acquisition of the target person image by the acquisition section, operation related to the authentication by the authentication section, or the automatic door opening operation by the door control device.

8. The entry system according to claim 1, wherein when the authentication section authenticates the target person in response to operation performed on an external operating unit that is provided on an outside of the vehicle, the door control section instructs the door control device to perform the automatic door unlocking of the vehicle door even in a middle of the temporary suspension period.

9. A door control method comprising the steps of:
acquiring, assuming a person present in a surrounding of a vehicle as a target person, a target person image that is an image of the target person;
performing authentication of the target person as a registered user having a usage right of the vehicle, based on the target person image; and
controlling a door to cause a door control device to execute automatic door unlocking and automatic door opening operation of a vehicle door under a condition in which the authentication succeeds, the door control device being configured to control locking/unlocking and opening/closing operation of the vehicle door of the vehicle,
wherein
in the controlling the door, when a predetermined transitioning condition is satisfied, predetermined operation related to the automatic door opening operation is prohibited during a temporary suspension period until a predetermined cancelling condition is satisfied, regardless of a result of the authentication.
